(19) United States
(12) Patent Application Publication
(10) Pub. No.: US 2025/0123800 A1
(43) Pub. Date: Apr. 17, 2025

(54) INFORMATION PROCESSING APPARATUS, VEHICLE, NON-TRANSITORY COMPUTER READABLE MEDIUM, AND CONTROL METHOD

(71) Applicant: TOYOTA JIDOSHA KABUSHIKI KAISHA, Toyota-shi Aichi-ken (JP)

(72) Inventors: Yu NAGATA, Chofu-shi Tokyo-to (JP); Ryota YANAGISAWA, Ota-ku Tokyo-to (JP); Akira MIYAMOTO, Nisshin-shi Aichi-ken (JP); Eiichi MAEDA, Asaka-shi Saitama-ken (JP); Haruto TOYAMA, Nagoya-shi Aichi-ken (JP); Kotaro HIROSE, Nisshin-shi Aichi-ken (JP); Yasuhiro KOBATAKE, Nagoya-shi Aichi-ken (JP)

(73) Assignee: TOYOTA JIDOSHA KABUSHIKI KAISHA, Toyota-shi Aichi-ken (JP)

(21) Appl. No.: 18/898,940

(22) Filed: Sep. 27, 2024

(30) Foreign Application Priority Data
Oct. 13, 2023 (JP) 2023-177810

(51) Int. Cl. G06F 3/16

(52) U.S. Cl. CPC G06F 3/167

(57) ABSTRACT

An information processing apparatus includes a controller configured to control a specific function in response to an operation that can be performed by both manual input and voice input. The controller is configured to notify an occupant of a vehicle that the operation can be performed by voice input, upon determining that the occupant has performed the operation by manual input, with a higher frequency when the occupant is a driver than when the occupant is not the driver.

### CROSS-REFERENCE TO RELATED APPLICATION

This application claims priority to Japanese Patent Application No. 2023-177810 filed on Oct. 13, 2023, the entire contents of which are incorporated herein by reference.

### TECHNICAL FIELD

The present disclosure relates to an information processing apparatus, a vehicle, a program, and a control method.

### BACKGROUND

Patent Literature (PTL) 1 discloses an apparatus that informs a user that voice input is possible when a command that can be input by voice input is input by manual input.

### CITATION LIST

### Patent Literature

PTL 1: JP 2003-114698 A

### SUMMARY

From a safety standpoint, it is desirable to actively suggest to drivers that commands be entered by voice input.

It would be helpful to actively suggest to drivers that operations be performed by voice input.

An information processing apparatus according to the present disclosure includes a controller configured to control a specific function in response to an operation that can be performed by both manual input and voice input, the controller being configured to notify an occupant of a vehicle that the operation can be performed by voice input, upon determining that the occupant has performed the operation by manual input, with a higher frequency when the occupant is a driver than when the occupant is not the driver.

A control method according to the present disclosure includes:
controlling, by a computer, a specific function in response to an operation that can be performed by both manual input and voice input; and
notifying, by the computer, an occupant of a vehicle that the operation can be performed by voice input, upon determining that the occupant has performed the operation by manual input, with a higher frequency when the occupant is a driver than when the occupant is not the driver.

According to the present disclosure, actively suggesting to drivers that operations be performed by voice input can contribute to improvement in safety.

### BRIEF DESCRIPTION OF THE DRAWINGS

In the accompanying drawings:

FIG. 1 is a diagram illustrating a configuration of a system according to an embodiment of the present disclosure;

FIG. 2 is a block diagram illustrating a configuration of an information processing apparatus according to the embodiment of the present disclosure;

FIG. 3 is a flowchart illustrating operations of the information processing apparatus according to the embodiment of the present disclosure;

FIG. 4 is a flowchart illustrating a variation of the operations illustrated in FIG. 3;

FIG. 5 is a flowchart illustrating additional operations of the information processing apparatus according to the embodiment of the present disclosure; and

FIG. 6 is a flowchart illustrating a variation of the operations illustrated in FIG. 5.

### DETAILED DESCRIPTION

An embodiment of the present disclosure will be described below, with reference to the drawings.

In the drawings, the same or corresponding portions are denoted by the same reference numerals. In the descriptions of the present embodiment, detailed descriptions of the same or corresponding portions are omitted or simplified, as appropriate.

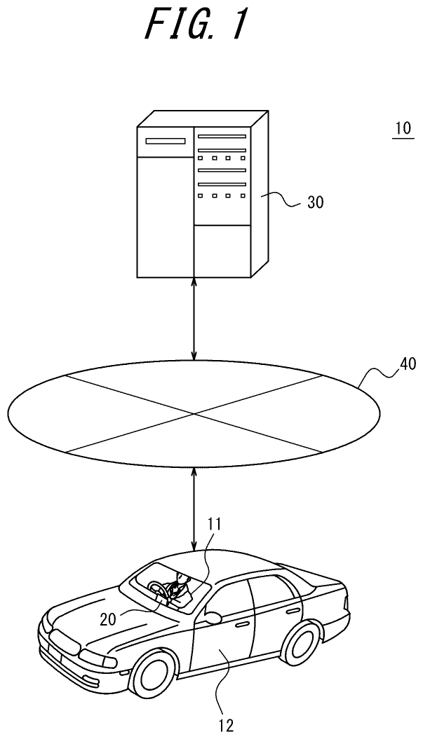

A configuration of a system 10 according to the present embodiment will be described with reference to FIG. 1.

The system 10 according to the present embodiment includes an information processing apparatus 20 and a server apparatus 30. The information processing apparatus 20 can communicate with the server apparatus 30 via a network 40.

The information processing apparatus 20 is a computer that is installed in a vehicle 12 and that has a voice recognition function. The information processing apparatus 20 is used by a user 11. The user 11 is an occupant of the vehicle 12.

The server apparatus 30 is a computer that belongs to a cloud computing system or other computing system installed in a facility such as a data center. The server apparatus 30 is operated by a service provider, such as a web service provider.

The vehicle 12 is, for example, any type of automobile such as a gasoline vehicle, a diesel vehicle, a hydrogen vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The vehicle 12 is driven by a driver, but the driving may be automated at any level. The automation level is, for example, any one of Level 1 to Level 4 according to the level classification defined by SAE. The name “SAE” is an abbreviation of Society of Automotive Engineers. The vehicle 12 may be a MaaS-dedicated vehicle. The term “MaaS” is an abbreviation of Mobility as a Service.

The network 40 includes the Internet, at least one WAN, at least one MAN, or any combination thereof. The term “WAN” is an abbreviation of wide area network. The term “MAN” is an abbreviation of metropolitan area network. The network 40 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation of local area network.

An outline of the present embodiment will be described with reference to FIG. 1.

The information processing apparatus 20 controls a specific function Fp in response to an operation that can be performed by both manual input and voice input. Upon determining that the user 11 has performed the operation by manual input, the information processing apparatus 20 notifies the user 11 that the operation can be performed by voice input, with a higher frequency when the user 11 is the driver than when the user 11 is not the driver.

According to the present embodiment, it is possible to actively suggest to the driver that the operation be performed by voice input. This can contribute to improvement in safety.

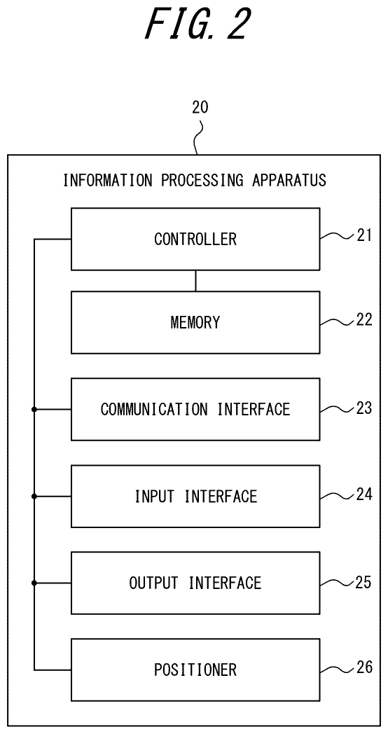

A configuration of the information processing apparatus 20 according to the present embodiment will be described with reference to FIG. 2.

The information processing apparatus 20 includes a controller 21, a memory 22, a communication interface 23, an input interface 24, an output interface 25, and a positioner 26.

The controller 21 includes at least one processor, at least one programmable circuit, at least one dedicated circuit, or any combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processes related to operations of the information processing apparatus 20 while controlling the components of the information processing apparatus 20.

The memory 22 includes at least one semiconductor memory, at least one magnetic memory, at least one optical memory, or any combination thereof. The semiconductor memory is, for example, RAM, ROM, or flash memory. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The flash memory is, for example, SSD. The term “SSD” is an abbreviation of solid-state drive. The magnetic memory is, for example, HDD. The term “HDD” is an abbreviation of hard disk drive. The memory 22 functions as, for example, a main memory, an auxiliary memory, or a cache memory. The memory 22 stores information to be used for the operations of the information processing apparatus 20 and information obtained by the operations of the information processing apparatus 20.

The communication interface 23 includes at least one communication module. The communication module is, for example, a module compatible with a mobile communication standard such as LTE, the 4G standard, or the 5G standard, or a wireless LAN communication standard such as IEEE802.11. The term “LTE” is an abbreviation of Long Term Evolution. The term “4G” is an abbreviation of 4th generation. The term “5G” is an abbreviation of 5th generation. The name “IEEE” is an abbreviation of Institute of Electrical and Electronics Engineers. The communication interface 23 communicates with the server apparatus 30. The communication interface 23 receives information to be used for the operations of the information processing apparatus 20, and transmits information obtained by the operations of the information processing apparatus 20.

The input interface 24 includes at least one input device. The input device is, for example, a physical key, a capacitive key, a pointing device, a touch screen integrally provided with a display, a visible light camera, a depth camera, a LIDAR sensor, or a microphone. The term “LiDAR” is an abbreviation of light detection and ranging. The input interface 24 accepts an operation for inputting information to be used for the operations of the information processing apparatus 20. The input interface 24, instead of being included in the information processing apparatus 20, may be connected to the information processing apparatus 20 as an external input device. As an interface for connection, an interface compliant with a standard such as USB, HDMI® (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface.

The output interface 25 includes at least one output device. The output device is, for example, a display or a speaker. The display is, for example, an LCD or an organic EL display. The term “LCD” is an abbreviation of liquid crystal display. The term “EL” is an abbreviation of electro luminescent. The output interface 25 outputs information obtained by the operations of the information processing apparatus 20. The output interface 25, instead of being included in the information processing apparatus 20, may be connected to the information processing apparatus 20 as an external output device such as a display audio. As an interface for connection, an interface compliant with a standard such as USB, HDMI® (HDMI is a registered trademark in Japan, other countries, or both), or Bluetooth® (Bluetooth is a registered trademark in Japan, other countries, or both) can be used.

The positioner 26 includes at least one GNSS receiver. The term “GNSS” is an abbreviation of global navigation satellite system. GNSS is, for example, GPS, QZSS, BDS, GLONASS, or Galileo. The term “GPS” is an abbreviation of Global Positioning System. The term “QZSS” is an abbreviation of Quasi-Zenith Satellite System. QZSS satellites are called quasi-zenith satellites. The term “BDS” is an abbreviation of BeiDou Navigation Satellite System. The term “GLONASS” is an abbreviation of Global Navigation Satellite System. The positioner 26 measures the position of the information processing apparatus 20.

The functions of the information processing apparatus 20 are realized by execution of a program according to the present embodiment by a processor serving as the controller 21. That is, the functions of the information processing apparatus 20 are realized by software. The program causes a computer to execute the operations of the information processing apparatus 20, thereby causing the computer to function as the information processing apparatus 20. That is, the computer executes the operations of the information processing apparatus 20 in accordance with the program to thereby function as the information processing apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the information processing apparatus 20 may be realized by a programmable circuit or a dedicated circuit serving as the controller 21. That is, some or all of the functions of the information processing apparatus 20 may be realized by hardware.

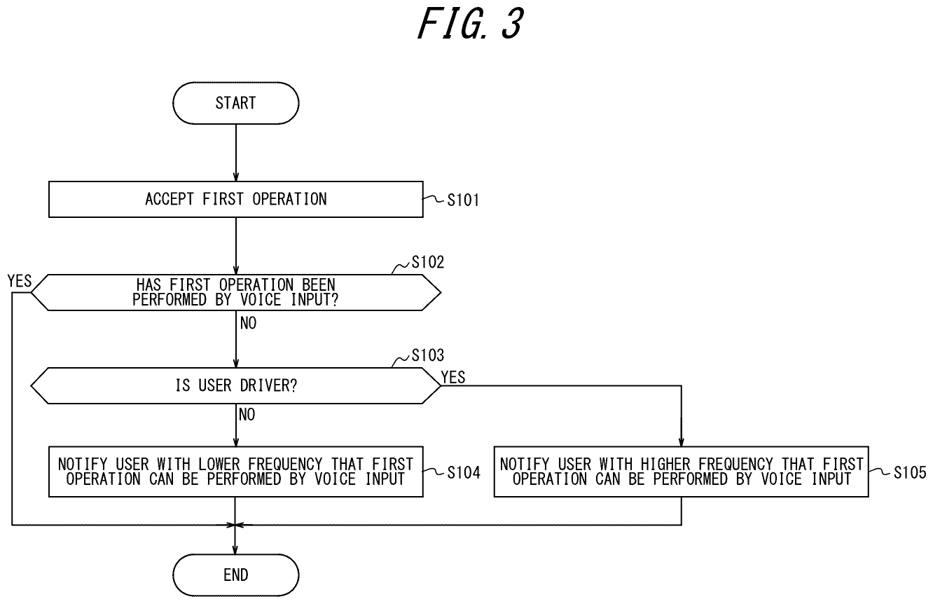

Operations of the information processing apparatus 20 according to the present embodiment will be described with reference to FIG. 3. The operations described below correspond to a control method according to the present embodiment. In other words, the control method according to the present embodiment includes steps S101 to S105 illustrated in FIG. 3.

In S101, the controller 21 accepts a first operation via the input interface 24. The first operation corresponds to an operation that can be performed by both manual input and voice input. For example, at least some operations for a device installed in the vehicle 12, such as a navigation device, audio device, information terminal device, or air conditioning device, can be performed by both manual input and voice input. Alternatively, at least some operations for the vehicle 12 itself may be performed by both manual input and voice input.

When the first operation is performed by manual input, the controller 21 accepts the first operation via the touch screen as the input interface 24, or via another input device that is directly touched by the user 11, as the input interface 24. When the first operation is performed by voice input, the controller 21 accepts the first operation via the microphone as the input interface 24.

In parallel with steps after S102, the controller 21 controls the specific function Fp in response to the first operation. The specific function Fp is a function of the device installed in the vehicle 12. Alternatively, the specific function Fp may be a function of the vehicle 12 itself. For example, upon accepting, as the first operation, an operation for the navigation device, the controller 21 controls a function of the navigation device, such as destination search. Upon accepting, as the first operation, an operation for the audio device, the controller 21 controls a function of the audio device, such as music play. Upon accepting, as the first operation, an operation for the information terminal device, the controller 21 controls a function of the information terminal device, such as the presentation of news, weather, or other information. Upon accepting, as the first operation, an operation for the air conditioning device, the controller 21 controls a function of the air conditioning device, such as adjusting temperature or air volume. Upon accepting, as the first operation, an operation for the vehicle 12 itself, the controller 21 controls a function of the vehicle 12 itself, such as opening and closing windows or a sunroof equipped on the vehicle 12, or presenting information regarding the vehicle 12, e.g., fuel consumption.

In S102, the controller 21 determines whether the first operation accepted in S101 has been performed by manual input or voice input. When it is determined that the first operation has been performed by voice input, the flow illustrated in FIG. 3 ends. When it is determined that the first operation has been performed by manual input, the step S103 is performed.

In S103, the controller 21 determines whether the user 11 is the driver. Specifically, the controller 21 recognizes the position and behavior of the user 11 by analyzing images in the vehicle 12 captured by a sensor such as a visible light camera, depth camera, or LiDAR sensor. As an image analysis method, a known method can be used. Machine learning, such as deep learning, may be used. Upon recognizing that the user 11 has performed the first operation in a seat other than the driver's seat, such as a passenger seat, the controller 21 determines that the user 11 is not the driver. On the other hand, upon recognizing that the user 11 has performed the first operation in the driver's seat, the controller 21 determines that the user 11 is the driver. Alternatively, the controller 21 may determine that user 11 is the driver when recognizing that there is only one occupant in the vehicle 12. When it is determined that user 11 is not the driver, step S104 is performed. When it is determined that the user 11 is the driver, step S105 is performed.

In S104, the controller 21 notifies the user 11 that the first operation can be performed by voice input, with a lower frequency than when the user 11 is the driver. Specifically, the controller 21 stores, in the memory 22 in advance, the number of times N1a that an occupant other than the driver has been notified that the operation can be performed by voice input, in a recent period, such as today, this week, or this month. Setting T1a at an integer greater than or equal to 0, when the number of times N1a stored in the memory 22 plus 1 does not exceed the threshold T1a, i.e., N1a+1<T1a or N1a+1=T1a, the controller 21 notifies the user 11 that the first operation can be performed by voice input. For example, the controller 21 outputs, from the speaker as the output interface 25, a voice message indicating that the first operation can be performed by voice input. When notifying the user 11 that the first operation can be performed by voice input, the controller 21 may display, on a screen, a message indicating that the first operation can be performed by voice input. In other words, the controller 21 may display, on the display as the output interface 25, the message indicating that the first operation can be performed by voice input. When the number of times N1a stored in the memory 22 plus 1 exceeds the threshold T1a, i.e., N1a+1>T1a, the controller 21 does not notify the user 11 that the first operation can be performed by voice input.

Instead of the number of times N1a in the recent period, the controller 21 may store, in the memory 22 in advance, the number of times N1b that the operation that can be performed by both manual input and voice input has been performed by manual input by the occupant other than the driver, and the number of times N1c that the occupant other than the driver has been notified that the operation can be performed by voice input. In such an example, setting T1b at a real number greater than or equal to 0, when the ratio of the number of times N1c stored in the memory 22 plus 1 to the number of times N1b stored in the memory 22 plus 1 does not exceed the threshold T1b, that is, (N1c+1)/(N1b+1)<T1b or (N1c+1)/(N1b+1)=T1b, the controller 21 notifies the user 11 that the first operation can be performed by voice input. When the ratio of the number of times N1c stored in the memory 22 plus 1 to the number of times N1b stored in the memory 22 plus 1 exceeds the threshold T1b, that is, (N1c+1)/(N1b+1)>T1b, the controller 21 does not notify the user 11 that the first operation can be performed by voice input.

The numbers of times N1a, N1b, and N1c may be stored in the memory 22 on a user-by-user basis, or may be stored in the memory 22 as total numbers of times for all users without distinguishing between users. The numbers of times N1a, N1b, and N1c may be stored in the server apparatus 30 or storage connected to the server apparatus 30, instead of being stored in the memory 22, and retrieved and updated via the communication interface 23.

In S105, the controller 21 notifies the user 11 that the first operation can be performed by voice input, with a higher frequency than when the user 11 is not the driver. Specifically, the controller 21 stores, in the memory 22 in advance, the number of times N2a that the driver has been notified in the recent period that the operation can be performed by voice input. Setting T2a at an integer greater than T1a, when the number of times N2a stored in the memory 22 plus 1 does not exceed the threshold T2a, i.e., N2a+1<T2a or N2a+1=T2a, the controller 21 notifies the user 11 that the first operation can be performed by voice input. For example, the controller 21 outputs, from the speaker as the output interface 25, the voice message indicating that the first operation can be performed by voice input. When notifying the user 11 that the first operation can be performed by voice input, the controller 21 may display, on the screen, the message indicating that the first operation can be performed by voice input. In other words, the controller 21 may display, on the display as the output interface 25, the message indicating that the first operation can be performed by voice input. When the number of times N2a stored in the memory 22 plus 1 exceeds the threshold T2a, i.e., N2a+1>T2a, the controller 21 does not notify the user 11 that the first operation can be performed by voice input.

Instead of the number of times N2a in the recent period, the controller 21 may store, in the memory 22 in advance, the number of times N2b that the operation that can be performed by both manual input and voice input has been performed by manual input by the driver, and the number of times N2c that the driver has been notified that the operation can be performed by voice input. In such an example, setting T2b at a real number greater than T1b, when the ratio of the number of times N2c stored in the memory 22 plus 1 to the number of times N2b stored in the memory 22 plus 1 does not exceed the threshold T2b, that is, (N2c+1)/(N2b+1)<T2b or (N2c+1)/(N2b+1)=T2b, the controller 21 notifies the user 11 that the first operation can be performed by voice input. When the ratio of the number of times N2c stored in the memory 22 plus 1 to the number of times N2b stored in the memory 22 plus 1 exceeds the threshold T2b, that is, (N2c+1)/(N2b+1)>T2b, the controller 21 does not notify the user 11 that the first operation can be performed by voice input.

The numbers of times N2a, N2b, and N2c may be stored in the memory 22 on a user-by-user basis, or may be stored in the memory 22 as total numbers of times for all users without distinguishing between users. The numbers of times N2a, N2b, and N2c may be stored in the server apparatus 30 or the storage connected to the server apparatus 30, instead of being stored in the memory 22, and retrieved and updated via the communication interface 23.

As described above, in the present embodiment, when the operation to be replaced by voice input is performed by manual input, the controller 21 notifies the user 11 that the operation can also be performed by voice input.

The controller 21 sets the frequency of notifications to the driver higher than the frequency of notifications to the occupant other than the driver. This can improve safety. The controller 21 may set the frequency of notifications to the driver who is driving further higher than the frequency of notifications to the driver who is not driving.

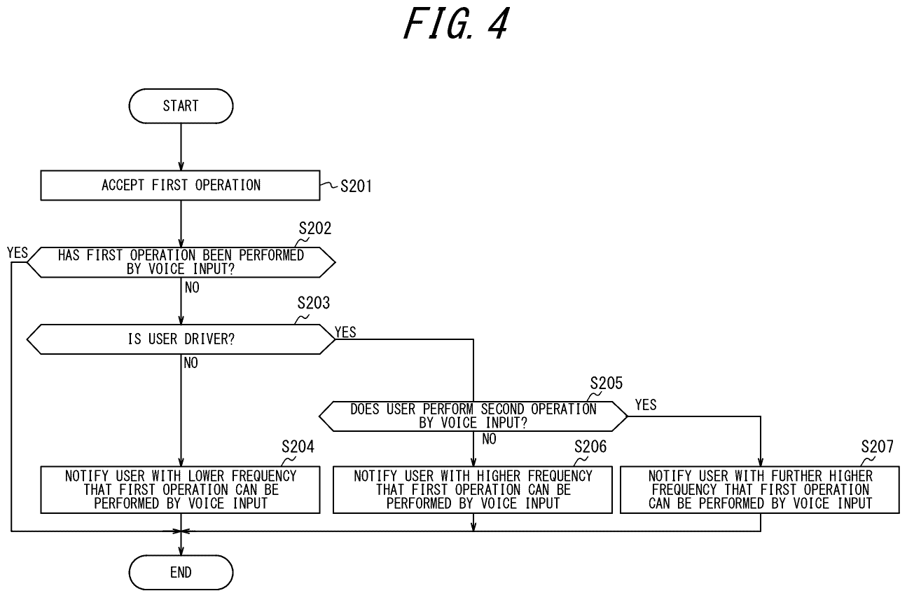

A variation of the operations illustrated in FIG. 3 will be described with reference to FIG. 4. However, steps S201 to S204 are the same as steps S101 to S104 illustrated in FIG. 3, respectively, and thus descriptions thereof are omitted. Also, step S206 is the same as step S105 illustrated in FIG. 3, and thus a description thereof is omitted.

When it is determined that the user 11 is the driver, step S205 is performed.

In S205, the controller 21 determines whether the user 11 performs a second operation by manual input or by voice input. The second operation is a different operation from the first operation, but as is the case with the first operation, corresponds to an operation that can be performed by both manual input and voice input. For example, when the first operation is an operation for the navigation device, the second operation may be any operation other than the operation for the navigation device, such as an operation for the audio device.

Specifically, the controller 21 determines whether the user 11 performs the second operation by manual input or by voice input, according to which is higher between a frequency with which the user 11 performs the second operation by manual input and a frequency with which the user 11 performs the second operation by voice input. More specifically, the controller 21 stores, in the memory 22 in advance, the number of times N3a that the second operation has been performed by manual input by the user 11, and the number of times N3b that the second operation has been performed by voice input by the user 11, in the recent period such as today, this week, or this month, or until now. When the number of times N3a stored in the memory 22 is greater than or equal to the number of times N3b stored in the memory 22, i.e., N3a>N3b or N3a=N3b, the controller 21 determines that the user 11 performs the second operation by manual input. When the number of times N3a stored in the memory 22 is less than the number of times N3b stored in the memory 22, i.e., N3a<N3b, the controller 21 determines that the user 11 performs the second operation by voice input. Alternatively, the controller 21 may determine whether the user 11 performs the second operation by manual input or by voice input, according to whether the user 11 has performed the second operation by manual input or by voice input when the user 11 has recently performed the second operation. When it is determined that user 11 performs the second operation by manual input, step S206 is performed. When it is determined that user 11 performs the second operation by voice input, step S207 is performed.

The numbers of times N3a and N3b may be stored in the server apparatus 30 or the storage connected to the server apparatus 30, instead of being stored in the memory 22, and retrieved and updated via the communication interface 23.

In S207, the controller 21 notifies the user 11 that the first operation can be performed by voice input, with a higher frequency than when the user 11 performs the second operation by manual input. Specifically, as is the case with the step S205, the controller 21 stores, in the memory 22 in advance, the number of times N2a that the driver has been notified in the recent period that the operation can be performed by voice input. Setting T3a at an integer greater than T2a, when the number of times N2a stored in the memory 22 plus 1 does not exceed the threshold T3a, i.e., N2a+1<T3a or N2a+1=T3a, the controller 21 notifies the user 11 that the first operation can be performed by voice input. For example, the controller 21 outputs, from the speaker as the output interface 25, the voice message indicating that the first operation can be performed by voice input. When notifying the user 11 that the first operation can be performed by voice input, the controller 21 may display, on the screen, the message indicating that the first operation can be performed by voice input. In other words, the controller 21 may display, on the display as the output interface 25, the message indicating that the first operation can be performed by voice input. When the number of times N2a stored in the memory 22 plus 1 exceeds the threshold T3a, i.e., N2a+1>T3a, the controller 21 does not notify the user 11 that the first operation can be performed by voice input.

As is the case with step S205, instead of the number of times N2a in the recent period, the controller 21 may store, in the memory 22 in advance, the number of times N2b that the operation that can be performed by both manual input and voice input has been performed by manual input by the driver, and the number of times N2c that the driver has been notified that the operation can be performed by voice input. In such an example, setting T3b at a real number greater than T2b, when the ratio of the number of times N2c stored in the memory 22 plus 1 to the number of times N2b stored in the memory 22 plus 1 does not exceed the threshold T3b, that is, (N2c+1)/(N2b+1)<T3b or (N2c+1)/(N2b+1)=T3b, the controller 21 notifies the user 11 that the first operation can be performed by voice input. When the ratio of the number of times N2c stored in the memory 22 plus 1 to the number of times N2b stored in the memory 22 plus 1 exceeds the threshold T3b, that is, (N2c+1)/(N2b+1)>T3b, the controller 21 does not notify the user 11 that the first operation can be performed by voice input.

As described above, when the operation to be replaced by voice input is performed by manual input, the controller 21 may set the frequency of notifications that the operation can be performed by voice input, to the driver who normally performs the other operation by voice input higher than the frequency of notifications to the driver who normally performs the other operation by manual input. The controller 21 may also set the frequency of notifications to the occupant other than the driver, who normally performs the other operation by voice input higher than the frequency of notifications to the occupant other than the driver, who normally performs the other operation by manual input.

In S105 in FIGS. 3 and S206 in FIG. 4, the controller 21 may notify the user 11 that the first operation can be performed by voice input, regardless of the number of times N2a, or the numbers of times N2b and N2c. In other words, when the first operation is performed by manual input by the driver, the controller 21 may always notify the driver that the first operation can be performed by voice input. Alternatively, when the first operation is performed by manual input by the driver who performs the second operation by voice input, the controller 21 may always notify the driver that the first operation can be performed by voice input.

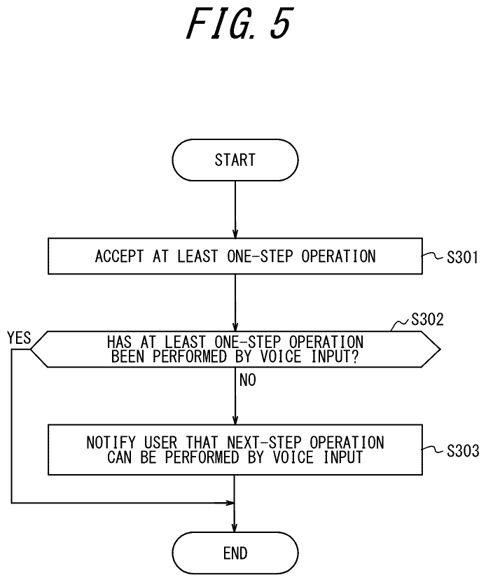

Additional operations of the information processing apparatus 20 according to the present embodiment will be described with reference to FIG. 5. The operations described below may be additionally applied to the control method according to the present embodiment. In other words, the control method according to the present embodiment may further include steps S301 to S303 illustrated in FIG. 5.

In S301, the controller 21 accepts, via the input interface 24, at least one-step operation among multiple-step operations. The multi-step operations each correspond to an operation that can be performed by both manual input and voice input, as is the case with the first operation. The multi-step operations are operations of sequentially selecting options included in a hierarchical menu, such as first selecting an artist or genre, then selecting an album, and finally selecting a song, on the audio device, for example. The multi-step operations may include the first operation, the second operation, or both.

When the at least one-step operation is performed by manual input, the controller 21 accepts the at least one-step operation, via the touch screen as the input interface 24, or another input device that is directly touched by the user 11 as the input interface 24. When the at least one-step operation is performed by voice input, the controller 21 accepts the at least one-step operation via the microphone as the input interface 24.

In parallel with steps after S302, the controller 21 controls the specific function Fp in response to the at least one-step operation. For example, upon accepting an operation of selecting an artist, as the at least one-step operation, on the audio device, the controller 21 controls the function of the audio device, such as searching for albums of the selected artist.

In S302, the controller 21 determines whether the at least one-step operation accepted in S301 has been performed by manual input or by voice input. When it is determined that the at least one-step operation has been performed by voice input, the flow illustrated in FIG. 5 ends. When it is determined that the at least one-step operation has been performed by manual input, step S303 is performed.

In S303, the controller 21 notifies the user 11 that the next-step operation can be performed by voice input. For example, the controller 21 outputs, from the speaker as the output interface 25, a voice message indicating that the next-step operation, such as an operation of selecting an album of the artist selected in the previous-step operation, can be performed by voice input. The controller 21 may display, on the display as the output interface 25, a message indicating that the next-step operation can be performed by voice input.

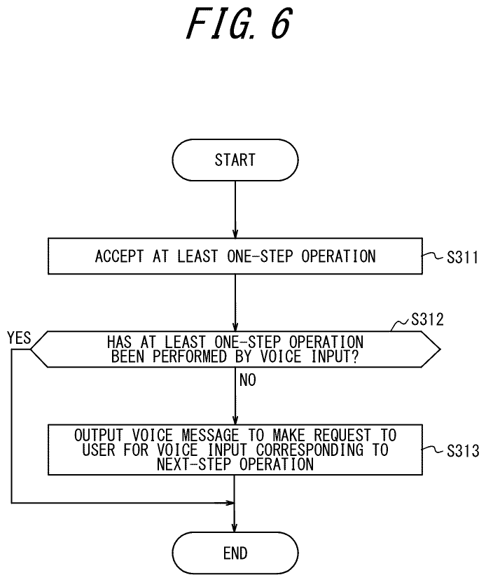

Another variation of the operations illustrated in FIG. 5 will be described with reference to FIG. 6. However, steps S311 and S312 are the same as steps S301 and S302 illustrated in FIG. 5, respectively, and thus descriptions thereof are omitted.

In S313, the controller 21 outputs a voice message to make a request to the user 11 for voice input corresponding to the next-step operation. For example, the controller 21 outputs audibly, from the speaker as the output interface 25, a question such as “Please say the name of an album.” or “Which album would you like to select?” in order to prompt the user 11 to say the name of an album of the artist selected in the previous-step operation.

The present disclosure is not limited to the embodiment described above. For example, two or more blocks described in the block diagram may be integrated, or a block may be divided. Instead of executing two or more steps described in the flowcharts in chronological order in accordance with the description, the steps may be executed in parallel or in a different order according to the processing capability of the apparatus that executes each step, or as required. Other modifications can be made without departing from the spirit of the present disclosure.

Examples of some embodiments of the present disclosure are described below. However, it should be noted that the embodiments of the present disclosure are not limited to these examples.
[APPENDIX 1] An information processing apparatus comprising a controller configured to control a specific function in response to an operation that can be performed by both manual input and voice input, the controller being configured to notify an occupant of a vehicle that the operation can be performed by voice input, upon determining that the occupant has performed the operation by manual input, with a higher frequency when the occupant is a driver than when the occupant is not the driver.
[APPENDIX 2] The information processing apparatus according to appendix 1, wherein at least when the occupant is the driver, upon determining that, among first and second operations each corresponding to the operation, the occupant has performed the first operation by manual input, the controller notifies the occupant that the first operation can be performed by voice input, with a higher frequency when the occupant performs the second operation by voice input than when the occupant performs the second operation by manual input.
[APPENDIX 3] The information processing apparatus according to appendix 2, wherein the controller is configured to determine whether the occupant performs the second operation by manual input or by voice input, according to which is higher between a frequency with which the occupant performs the second operation by manual input and a frequency with which the occupant performs the second operation by voice input.
[APPENDIX 4] The information processing apparatus according to appendix 2, wherein the controller is configured to determine whether the occupant performs the second operation by manual input or by voice input, according to whether the occupant has performed the second operation by manual input or by voice input when the occupant has recently performed the second operation.
[APPENDIX 5] The information processing apparatus according to any one of appendices 1 to 4, wherein upon determining that the occupant has performed, by manual input, at least one-step operation, among multiple-step operations each corresponding to the operation, the controller is configured to notify the occupant that a next-step operation can be performed by voice input.
[APPENDIX 6] The information processing apparatus according to appendix 5, wherein the multiple-step operations are operations of sequentially selecting options included in a hierarchical menu.
[APPENDIX 7] The information processing apparatus according to any one of appendices 1 to 4, wherein upon determining that the occupant has performed, by manual input, at least one-step operation, among multiple-step operations each corresponding to the operation, the controller is configured to output a voice message to make a request to the occupant for voice input corresponding to a next-step operation.
[APPENDIX 8] The information processing apparatus according to appendix 7, wherein the multiple-step operations are operations of sequentially selecting options included in a hierarchical menu.
[APPENDIX 9] The information processing apparatus according to any one of appendices 1 to 8, wherein when notifying the occupant that the operation can be performed by voice input, the controller is configured to display, on a screen, a message indicating that the operation can be performed by voice input.
[APPENDIX 10] The information processing apparatus according to any one of appendices 1 to 9, wherein the specific function is a function of the vehicle or a device installed in the vehicle.
[APPENDIX 11] A vehicle comprising the information processing apparatus according to any one of appendices 1 to 10.
[APPENDIX 12] A program configured to cause a computer to function as the information processing apparatus according to any one of appendices 1 to 10.
[APPENDIX 13] A control method comprising:
   controlling, by a computer, a specific function in response to an operation that can be performed by both manual input and voice input; and
   notifying, by the computer, an occupant of a vehicle that the operation can be performed by voice input, upon determining that the occupant has performed the operation by manual input, with a higher frequency when the occupant is a driver than when the occupant is not the driver.
[APPENDIX 14] The control method according to appendix 13, further comprising, upon determining that, among first and second operations each corresponding to the operation, the occupant has performed the first operation by manual input, notifying, by the computer, the occupant that the first operation can be performed by voice input, with a higher frequency when the occupant performs the second operation by voice input than when the occupant performs the second operation by manual input.
[APPENDIX 15] The control method according to appendix 14, further comprising determining, by the computer, whether the occupant performs the second operation by manual input or by voice input, according to which is higher between a frequency with which the occupant performs the second operation by manual input and a frequency with which the occupant performs the second operation by voice input.
[APPENDIX 16] The control method according to appendix 14, further comprising determining, by the computer, whether the occupant performs the second operation by manual input or by voice input, according to whether the occupant has performed the second operation by manual input or by voice input when the occupant has recently performed the second operation.
[APPENDIX 17] The control method according to any one of appendices 13 to 16, further comprising, upon determining that the occupant has performed, by manual input, at least one-step operation, among multiple-step operations each corresponding to the operation, notifying, by the computer, the occupant that a next-step operation can be performed by voice input.
[APPENDIX 18] The control method according to appendix 17, wherein the multiple-step operations are operations of sequentially selecting options included in a hierarchical menu.
[APPENDIX 19] The control method according to any one of appendices 13 to 16, further comprising, upon determining that the occupant has performed, by manual input, at least one-step operation, among multiple-step operations each corresponding to the operation, outputting, by the computer, a voice message to make a request to the occupant for voice input corresponding to a next-step operation.
[APPENDIX 20] The control method according to appendix 19, wherein the multiple-step operations are operations of sequentially selecting options included in a hierarchical menu.

1. An information processing apparatus comprising a controller configured to control a specific function in response to an operation that can be performed by both manual input and voice input, the controller being configured to notify an occupant of a vehicle that the operation can be performed by voice input, upon determining that the occupant has performed the operation by manual input, with a higher frequency when the occupant is a driver than when the occupant is not the driver.

2. The information processing apparatus according to claim 1, wherein at least when the occupant is the driver, upon determining that, among first and second operations each corresponding to the operation, the occupant has performed the first operation by manual input, the controller notifies the occupant that the first operation can be performed by voice input, with a higher frequency when the occupant performs the second operation by voice input than when the occupant performs the second operation by manual input.

3. The information processing apparatus according to claim 2, wherein the controller is configured to determine whether the occupant performs the second operation by manual input or by voice input, according to which is higher between a frequency with which the occupant performs the second operation by manual input and a frequency with which the occupant performs the second operation by voice input.

4. The information processing apparatus according to claim 2, wherein the controller is configured to determine whether the occupant performs the second operation by manual input or by voice input, according to whether the occupant has performed the second operation by manual input or by voice input when the occupant has recently performed the second operation.

5. The information processing apparatus according to claim 1, wherein upon determining that the occupant has performed, by manual input, at least one-step operation, among multiple-step operations each corresponding to the operation, the controller is configured to notify the occupant that a next-step operation can be performed by voice input.

6. The information processing apparatus according to claim 5, wherein the multiple-step operations are operations of sequentially selecting options included in a hierarchical menu.

7. The information processing apparatus according to claim 1, wherein upon determining that the occupant has performed, by manual input, least one-step operation, among multiple-step operations each at corresponding to the operation, the controller is configured to output a voice message to make a request to the occupant for voice input corresponding to a next-step operation.

8. The information processing apparatus according to claim 7, wherein the multiple-step operations are operations of sequentially selecting options included in a hierarchical menu.

9. The information processing apparatus according to claim 1, wherein when notifying the occupant that the operation can be performed by voice input, the controller is configured to display, on a screen, a message indicating that the operation can be performed by voice input.

10. The information processing apparatus according to claim 1, wherein the specific function is a function of the vehicle or a device installed in the vehicle.

11. A vehicle comprising the information processing apparatus according to claim 1.

12. A non-transitory computer readable medium storing a program configured to cause a computer to function as the information processing apparatus according to claim 1.

13. A control method comprising:
controlling, by a computer, a specific function in response to an operation that can be performed by both manual input and voice input; and
notifying, by the computer, an occupant of a vehicle that the operation can be performed by voice input, upon determining that the occupant has performed the operation by manual input, with a higher frequency when the occupant is a driver than when the occupant is not the driver.

14. The control method according to claim 13, further comprising, upon determining that, among first and second operations each corresponding to the operation, the occupant has performed the first operation by manual input, notifying, by the computer, the occupant that the first operation can be performed by voice input, with a higher frequency when the occupant performs the second operation by voice input than when the occupant performs the second operation by manual input.

15. The control method according to claim 14, further comprising determining, by the computer, whether the occupant performs the second operation by manual input or by voice input, according to which is higher between a frequency with which the occupant performs the second operation by manual input and a frequency with which the occupant performs the second operation by voice input.

16. The control method according to claim 14, further comprising determining, by the computer, whether the occupant performs the second operation by manual input or by voice input, according to whether the occupant has performed the second operation by manual input or by voice input when the occupant has recently performed the second operation.

17. The control method according to claim 13, further comprising, upon determining that the occupant has performed, by manual input, at least one-step operation, among multiple-step operations each corresponding to the operation, notifying, by the computer, the occupant that a next-step operation can be performed by voice input.

18. The control method according to claim 17, wherein the multiple-step operations are operations of sequentially selecting options included in a hierarchical menu.

19. The control method according to claim 13, further comprising, upon determining that the occupant has performed, by manual input, at least one-step operation, among multiple-step operations each corresponding to the operation, outputting, by the computer, a voice message to make a request to the occupant for voice input corresponding to a next-step operation.

20. The control method according to claim 19, wherein the multiple-step operations are operations of sequentially selecting options included in a hierarchical menu.
